(19) United States
(12) Patent Application Publication
(10) Pub. No.: US 2026/0237702 A1
(43) Pub. Date: Aug. 13, 2026

(54) FUEL CELL - ELECTROLYZER OR REVERSIBLE FUEL CELL SYSTEM AND METHODS OF OPERATING THEREOF WITH A REDUCED CARBON FOOTPRINT

(71) Applicant: BLOOM ENERGY CORPORATION, San Jose, CA (US)

(72) Inventors: Afshin MAJD, San Jose, CA (US); Emad EL BATAWI, Aurora, CO (US); Martin PERRY, Mountain View, CA (US); Prasad PMSVVSV, Sunnyvale, CA (US); Carlton COTTULI, Franklin, MA (US)

(21) Appl. No.: 18/988,052

(22) Filed: Dec. 19, 2024

Related U.S. Application Data
(60) Provisional application No. 63/612,609, filed on Dec. 20, 2023.

(51) Int. Cl. H01M 8/0656; C25B 1/042; C25B 15/08; H01M 8/04082; H01M 8/04858; H01M 8/12; H02J 3/466; H02J 101/10; H02J 101/30

(52) U.S. Cl. CPC H01M 8/0656; C25B 1/042; C25B 15/081; H01M 8/04201; H01M 8/04925; H01M 8/12; H02J 3/466; H01M 2008/1293; H02J 2101/10; H02J 2101/30

(57) ABSTRACT

A power generation system includes an electrolyzer system configured to generate hydrogen using power received from a power grid, a hydrogen storage device configured to store generated hydrogen, a fuel cell system configured to generate power for a load using at least one of hydrogen received directly from the electrolyzer system, hydrogen received from the hydrogen storage device, or a hydrocarbon fuel received from a hydrocarbon fuel supply, and a controller configured to determine a CO₂ per kWh power grid emission rate (GER) of a power grid electrically connected to the power system, and control operation of the fuel cell system and the electrolyzer system based on a comparison between the GER, a CO₂ per kWh hydrocarbon fuel (e.g., natural gas) emission rate of the fuel cell system (NER), and a CO₂ per kWh target emission rate (TER) that is less than the NER.

### FIELD

Aspects of the present disclosure relate generally to fuel cell and electrolyzer systems and to methods of operating thereof with a reduced carbon footprint.

### BACKGROUND

A fuel cell stack may include multiple fuel cells separated by metallic interconnects (IC) which provide both electrical connection between adjacent cells in the stack and channels for delivery and removal of fuel and oxidant. An electrolyzer cell stack may include multiple electrolyzer cells separated by metallic interconnects (IC) which provide both electrical connection between adjacent cells in the stack and channels for delivery and removal of steam and optional air sweep gas.

### SUMMARY

An embodiment method of operating a power system comprising a fuel cell system and an electrolyzer system, includes (A) determining a CO₂ per kilowatt hour (kWh) power grid emission rate (GER) of a power grid electrically connected to the power system; and (B) controlling operation of the power system based on a comparison between the GER, a CO₂ per kWh hydrocarbon fuel emission rate of the fuel cell system (NER), and a CO₂ per kWh target emission rate (TER) that is less than the NER. In performance of the method, if NER>TER>GER, controlling the power system to provide power from the power grid to the electrolyzer system to generate hydrogen, and provide the generated hydrogen to the fuel cell system to generate power for a load; if NER>GER>TER, controlling the power system to provide power from the power grid to the electrolyzer system to generate hydrogen, and provide the generated hydrogen and stored hydrogen that was previously generated by the electrolyzer system to the fuel cell system to generate power for the load; and if GER>NER>TER, controlling the power system to provide the stored hydrogen and a hydrocarbon fuel to the fuel cell system to generate power for the load.

Another embodiment method of operating a reversible fuel cell system includes (A) determining a CO₂ per kilowatt hour (kWh) power grid emission rate (GER) of a power grid electrically connected to the reversible fuel cell system; and (B) controlling the reversible fuel cell system based on a comparison between the GER, a CO₂ per kWh hydrocarbon fuel emission rate of the reversible fuel cell system (NER), and a CO₂ per kWh target emission rate (TER) that is less than the NER. In performance of the method, if NER>TER>GER, operating the reversible fuel cell system in an electrolyzer mode using power received from the power grid to generate hydrogen, and storing the generated hydrogen; if NER>GER>TER, operating the reversible fuel cell system in a fuel cell mode using stored hydrogen to generate power that is provided to a load; and if GER>NER>TER, operating the reversible fuel cell system in the fuel cell mode using stored hydrogen and a hydrocarbon fuel to generate power that is provided to the load.

An embodiment power generation system that is configured to be electrically connected to a power grid and a load includes an electrolyzer system configured to generate hydrogen using power received from the power grid; a hydrogen storage device configured to store the generated hydrogen; a fuel cell system configured to generate power for the load using at least one of hydrogen received directly from the electrolyzer system, hydrogen received from the hydrogen storage device, or a hydrocarbon fuel received from a hydrocarbon fuel supply; and a controller configured to: (A) determine a CO₂ per kilowatt hour (kWh) power grid emission rate (GER) of a power grid electrically connected to the power system; and (B) control operation of the fuel cell system and the electrolyzer system based on a comparison between the GER, a CO₂ per kWh hydrocarbon fuel emission rate of the fuel cell system (NER), and a CO₂ per kWh target emission rate (TER) that is less than the NER. If NER>TER>GER, the controller will control the power generation system to provide power from the power grid to the electrolyzer system to generate hydrogen, and provide the generated hydrogen to the fuel cell system to generate power for a load; if NER>GER>TER, the controller will control the power generation system to provide power from the power grid to the electrolyzer system to generate hydrogen (H₂), and provide generated hydrogen and stored hydrogen that was previously generated by the electrolyzer system to the fuel cell system to generate power for the load; and if GER>NER>TER, the controller will control the power generation system to provide the stored hydrogen and a hydrocarbon fuel to the fuel cell system to generate power for the load.

Another embodiment power generation system that is configured to be electrically connected to a power grid and a load includes a hydrogen storage device configured to store generated hydrogen; a reversible fuel cell system configured to generate hydrogen using power received from the power grid in an electrolysis mode, and to generate power for the load using at least one of hydrogen received from the hydrogen storage device or a hydrocarbon fuel received from a hydrocarbon fuel supply in a fuel cell mode; and a controller configured to: (A) determine a CO₂ per kilowatt hour (kWh) power grid emission rate (GER) of a power grid electrically connected to the reversible fuel cell system; and (B) control the reversible fuel cell system based on a comparison between the GER, a CO₂ per kWh hydrocarbon fuel emission rate of the reversible fuel cell system (NER), and a CO₂ per kWh target emission rate (TER) that is less than the NER. If NER>TER>GER, controlling the power generation system to operate the reversible fuel cell system in the electrolyzer mode using power received from the power grid to generate hydrogen, and storing the generated hydrogen; if NER>GER>TER, controlling the power generation system to operate the reversible fuel cell system in the fuel cell mode using stored hydrogen to generate power that is provided to a load; and if GER>NER>TER, controlling the power generation system to operate the reversible fuel cell system in the fuel cell mode using stored hydrogen and a hydrocarbon fuel to generate power that is provided to the load.

### BRIEF DESCRIPTION OF THE DRAWINGS

The accompanying drawings, which are included to provide a further understanding of the invention and are incorporated in and constitute a part of this specification, illustrate exemplary embodiments of the invention, and, together with the description, serve to explain the principles of the invention.

FIG. 1A is a perspective view of an electrochemical cell stack, according to various embodiments of the present disclosure.

FIG. 1B is a cross-sectional view of a portion of the stack of FIG. 1A.

FIG. 2 is a schematic view of a power generation system, according to a first embodiment of the present disclosure.

FIG. 3 is a schematic view of a power generation system, according to a second embodiment of the present disclosure.

FIG. 4 is a flow chart illustrating a power generation method according to the first embodiment of the present disclosure.

FIG. 5 is a flow chart illustrating a power generation method according to the second embodiment of the present disclosure.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Herein the term “about” refers to a range of +/−1% with respect to a corresponding value.

Electrochemical cell systems include fuel cell and electrolyzer cell systems. In a high temperature fuel cell system, such as a solid oxide fuel cell (SOFC) system, an oxidizing flow is directed to the air (i.e., cathode) side of the fuel cell while a fuel flow is directed to the fuel (e.g., anode) side of the fuel cell. The oxidizing flow is typically air, while the fuel flow can be hydrogen (H₂), ammonia or a hydrocarbon fuel, such as methane, natural gas, ethanol, or methanol. The fuel cell, operating at a temperature between 750° C. and 950° C., enables the transport of negatively charged oxygen ions from the air flow stream to the fuel flow stream, where the ions combine with either free hydrogen or hydrogen in a hydrocarbon molecule to form water vapor and/or with carbon monoxide to form carbon dioxide. The excess electrons from the negatively charged ions are routed back to the air side of the fuel cell through an electrical circuit completed between fuel electrode and the air electrode, resulting in an electrical current flow through the circuit.

In an electrolyzer system, such as a solid oxide electrolyzer system (SOEC), water (e.g., steam) is separated into hydrogen and oxygen by applying a voltage across the electrolyzer cells. In a SOEC stack, the anode is the air electrode and the cathode is the fuel electrode. Thus, the electrode to which the fuel (e.g., hydrogen or hydrocarbon fuel in a SOFC, and water in a SOEC) is supplied may be referred to as the fuel electrode and the opposing electrode may be referred to as the air electrode in both SOFC and SOEC cells.

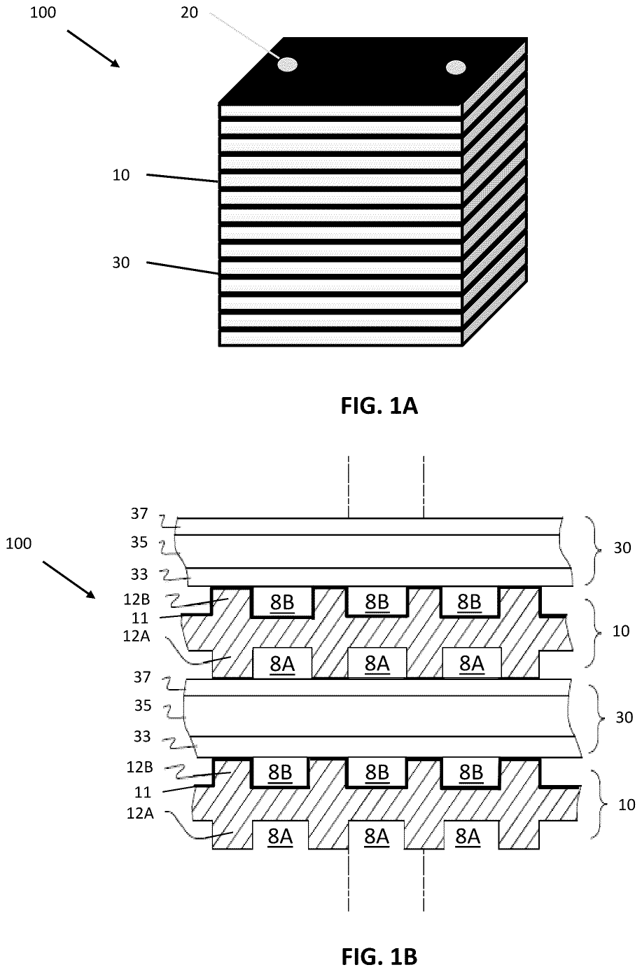

FIG. 1A is a perspective view of an electrochemical cell stack 100 and FIG. 1B is a sectional view of a portion of the stack 100, according to various embodiments of the present disclosure. The stack 100 may be a solid oxide fuel cell (SOFC) stack or a solid oxide electrolyzer cell (SOEC) stack. Referring to FIGS. 1A and 1B, the stack 100 includes electrochemical cells 30 separated by interconnects 10. Referring to FIG. 1B, each electrochemical cell 30 comprises an air electrode 33, a solid oxide electrolyte 35, and a fuel electrode 37.

Various materials may be used for the air electrode 33, electrolyte 35, and fuel electrode 37. For example, the fuel electrode 37 may comprise a cermet comprising a nickel containing phase and a ceramic phase. The nickel containing phase may consist entirely of nickel in a reduced state. This phase may form nickel oxide when it is in an oxidized state. Thus, the fuel electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The air electrode 33 may comprise an electrically conductive material, such as an electrically conductive perovskite material, such as lanthanum strontium manganite (LSM). Other conductive perovskites, such as LSCo, etc., or metals, such as Pt, may also be used. The air electrode 33 may also contain a ceramic phase similar to the fuel electrode 37. The electrodes and the electrolyte may each comprise one or more sublayers of one or more of the above described materials.

Electrochemical cell stacks 100 are frequently built from a multiplicity of SOFCs 30 in the form of planar elements, tubes, or other geometries. Although the electrochemical cell stack 100 in FIG. 1A is vertically oriented, electrochemical cell stacks may be oriented horizontally or in any other direction. Fuel and air may be provided to the electrochemically active surface, which can be large. For example, fuel may be provided through fuel holes 20 formed in each interconnect 10. The fuel holes 20 may be aligned to form fuel conduits (i.e., fuel riser openings) that extend through the stack 100.

Each interconnect 10 electrically connects adjacent electrochemical cells 30 in the stack 100. In particular, an interconnect 10 may electrically connect the fuel electrode 37 of one electrochemical cell 30 to the air electrode 33 of an adjacent electrochemical cell 30. FIG. 1B shows that the lower electrochemical cell 30 is located between two interconnects 10. An optional Ni mesh may be used to electrically connect the interconnect 10 to the fuel electrode 37 of an adjacent electrochemical cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode 37 of one cell in the stack from oxidant, such as air, flowing to the air electrode 33 of an adjacent cell in the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy). Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe) may be used. A protective layer 11, which may be formed of an electrically conductive material, such as lanthanum strontium manganite (LSM) and/or a spinel manganese cobalt oxide (MCO), may be provided on an air side of each interconnect 10.

Electrolyzer systems use direct current (DC) electric power to produce hydrogen. The produced hydrogen can then be used as a fuel to generate electricity in a fuel cell system with no carbon emissions. The power used to generate hydrogen can come from different sources, such as fossil fuel sources (e.g., coal or gas fired power plants that provide electricity to a power grid) that emit carbon dioxide, and green energy sources that do not emit carbon dioxide, such as wind, solar, and hydro power sources. Wind and solar power source produce power intermittently. For example, wind and solar plants power production may have to be curtailed if power generation exceeds demand, or the power generation may be insufficient to meet demand during periods of low generation. As such, there is a need for systems and methods that generate power with no or reduced carbon dioxide generation.

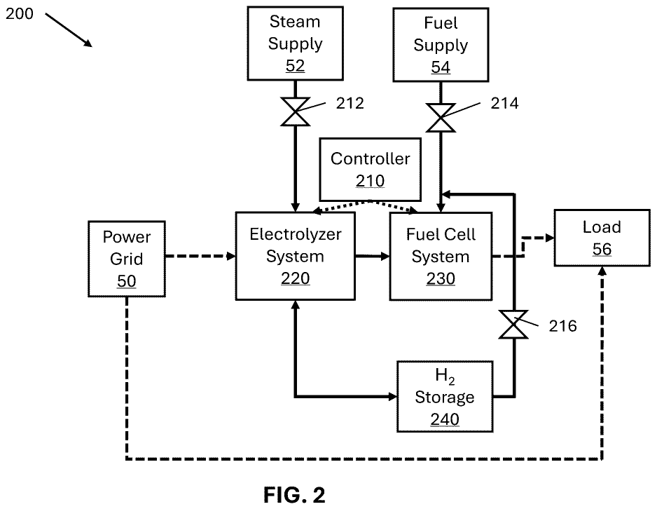

FIG. 2 is a schematic view of a power generation system 200, according to a first embodiment of the present disclosure. Referring to FIG. 2, the system 200 may include a controller 210, an electrolyzer system 220, a fuel cell system 230, and a hydrogen storage device 240. The system 200 may also optionally include a steam valve 212, a fuel valve 214, and a hydrogen valve 216. The system 200 may be electrically connected to a power grid 50 and an electrical load 56, and the system 200 may be fluidly connected to a steam supply 52 and a fuel supply 54.

The power grid 50 may be a utility power grid or a microgrid that receives power from conventional and/or renewable power generation systems. As such, the amount of carbon emitted per kWh of power provided by the power grid 50 may vary over time in accordance with the generation rates of the renewable power sources. The power grid 50 may be an alternating current (AC) power source.

In some embodiments, the load 56 may be an AC load or a DC load. For example, the load 56 may be a data center DC load that utilizes a dedicated fuel cell DC power source to ensure power reliability. In some embodiments, the load 56 may include a rectifier in order to utilize the power grid 50 as a backup power source.

The electrolyzer system 220 may include one or more stacks 100 or columns of stacks 100 of electrolyzer cells 30, such as solid oxide electrolyzer cells. The electrolyzer cells convert steam into a hydrogen product by electrolysis of steam using electric power provided from the power grid 50. An air sweep gas may be provided to the air electrodes of the electrolyzer cells 30 to remove the oxygen generated by the electrolysis of steam. Hydrogen gas generated by the electrolyzer system 220 may be provided to the fuel cell system 230 to be used as fuel in the fuel cell stack 100 to generate carbon-free electricity (i.e., to generate electric power without any carbon dioxide emissions). For example, the hydrogen may be provided directly from the electrolyzer system 220 to the fuel cell system 230 or may be stored in the hydrogen storage device 240 before being provided to the fuel cell system 230. In some embodiments, hydrogen may be provided to the fuel cell system 230 concurrently from both the electrolyzer system 220 and from the hydrogen storage device 240.

The fuel cell system 230 may include one or more stacks 100 or columns of stacks of fuel cells, such as solid oxide fuel cells. The fuel cell system 230 may generate electricity using a hydrocarbon fuel, such as natural gas, provided from the fuel supply 54 and/or using hydrogen provided from the electrolyzer system 220 and/or from the hydrogen storage device 240. Electricity generated by the fuel cell system 230 may be provided to the electrical load 56.

The steam supply 52 may comprise a building or factory steam source (e.g., external boiler, etc.), which provides byproduct steam to the electrolyzer cell stack 100 of the electrolyzer system 220, and/or a dedicated steam generator which is part of the electrolyzer system 220. The fuel supply 54 may comprise a natural gas pipeline or a hydrocarbon fuel (e.g., methane, pentane, etc.) storage vessel.

The hydrogen storage device 240 may be any suitable hydrogen storage device, such as a gas storage tank. In some embodiments, hydrogen from the hydrogen storage device 240 may be mixed with the steam provided to the electrolyzer system 220, in order to remove oxygen (O₂) from the steam and/or during start-up and shutdown of the electrolyzer system 220. The valves 212, 214, 216 may be any suitable type of valve, such as an electrically or pneumatically actuated valves.

The controller 210 may include a central processing unit and a memory configured to store computer readable instructions, such as a general purpose computer, a special purpose computer, etc. The controller 210 may be configured to control operation of the electrolyzer system 220, the fuel cell system 230 and the various valves 212, 214 and 216. For example, the controller 210 may be configured to control the power electronics (e.g., AC-DC inverter and/or one or more DC-DC converters) of electrolyzer system 220 to control electric power flow from the power grid 50 to the electrolyzer system 220. In other words, the controller 210 may turn off, turn on, increase and decrease the electric power provided from the power grid 50 to the electrolyzer system 220. The controller 210 may also control the steam valve 212 to control steam flow from the steam supply 52 to the electrolyzer system 220. In other words, the controller 210 may turn off and turn on, and optionally increase and decrease the steam flow from the steam supply 52 to the electrolyzer system 220.

The controller 210 may also be configured to control the fuel valve 214 to control fuel flow from the fuel supply 54 to the fuel cell system 230. In other words, the controller 210 may turn off and turn on, and optionally increase and decrease (if the fuel valve 214 is a proportional valve) the fuel (e.g., hydrocarbon fuel) flow provided from the fuel supply 54 to the fuel cell system 230. The controller 210 may also be configured to control the hydrogen valve 216 to control hydrogen flow from the hydrogen storage device 240 to the fuel cell system 230. In other words, the controller 210 may turn off and turn on, and optionally increase and decrease (if the hydrogen valve 216 is a proportional valve) the hydrogen flow from the hydrogen storage device 240 to the fuel cell system 230.

In some embodiments, the controller 210 may be configured to determine a grid emission rate (GER) (i.e., an amount of CO₂ emitted per kWh by sources powering the grid). For example, if the power grid 50 is receiving an increasing portion of electric power from fossil fuel power plants (e.g., coal or gas fired power plants), and a decreasing portion of electric power from renewable power plants (e.g., solar, wind, hydro, etc., plants), then the GER value increases. Alternatively, if the power grid 50 is receiving a decreasing portion of electric power from fossil fuel power plants (e.g., coal or gas fired power plants), and an increasing portion of electric power from renewable power plants (e.g., solar, wind, hydro, etc., plants), then the GER value increases.

The controller 210 may be configured to receive the GER from a grid utility via the Internet or may be configured to estimate a GER based on available data. The controller 210 may be configured to store a hydrocarbon fuel (e.g., natural gas) emission rate (NER) (i.e., an amount of CO₂ emitted per kWh by the fuel cell system 230 when generating power using a natural gas fuel). The NER may be a measurement of the efficiency of the fuel cell system 230. The controller 210 may also be configured to store or receive a target emission rate (TER) (i.e., a total amount of CO₂ emitted per kWh by the system 200 based on the GER and NER values). The TER may be set by an operator of the system 200 either directly or via the Internet, or the TER may be a constant value stored in the controller 210. The controller 210 may also be configured to determine the magnitude of the power requirements (i.e., load demand) of the load 56.

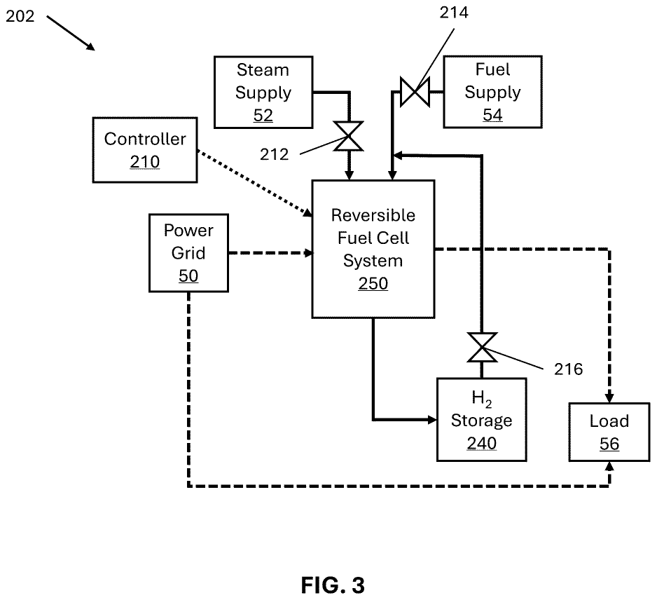

FIG. 3 is a schematic view of a power generation system 202, according to a second embodiment of the present disclosure. The system 202 may be similar to the system 200. As such, only the differences therebetween will be discussed in detail.

Referring to FIG. 3, the system 202 may include a reversible fuel cell system 250 instead of the electrolyzer system 220 and the fuel cell system 230. In particular, the reversible fuel cell system 250 may comprise one or more stacks 100 or columns of stacks of reversible fuel cells, such as reversible solid oxide fuel cells, configured to operate in a fuel cell mode to generate electric power from a fuel (e.g., hydrogen and/or hydrocarbon fuel) and to operate in an electrolyzer mode to generate hydrogen by electrolysis of steam. When operating in the electrolyzer mode, the reversible fuel cell system 250 is provided electric power from the power grid 50 and steam from the steam supply 52 to generate the hydrogen, and the generated hydrogen may be stored in the hydrogen storage device 240. During the electrolyzer mode operation, the load 56 may be powered by the power grid 50. As such, excess power generated by renewable energy sources connected to the power grid 50 may be utilized by the system 202 to generate hydrogen and to power the load 56.

When operating in fuel cell mode, hydrogen fuel may be provided from the hydrogen storage device 240 to the reversible fuel cell system 250 to generate power for the load 56. In some embodiments, a hydrocarbon fuel, such as natural gas, may be provided to the reversible fuel cell system 250 from the fuel supply 54 to supplement and/or the replace the hydrogen fuel. For example, the reversible fuel cell system 250 may be operated using natural gas if the hydrogen in the hydrogen storage device 240 is exhausted or is insufficient for the reversible fuel cell system 250 to power the load 56.

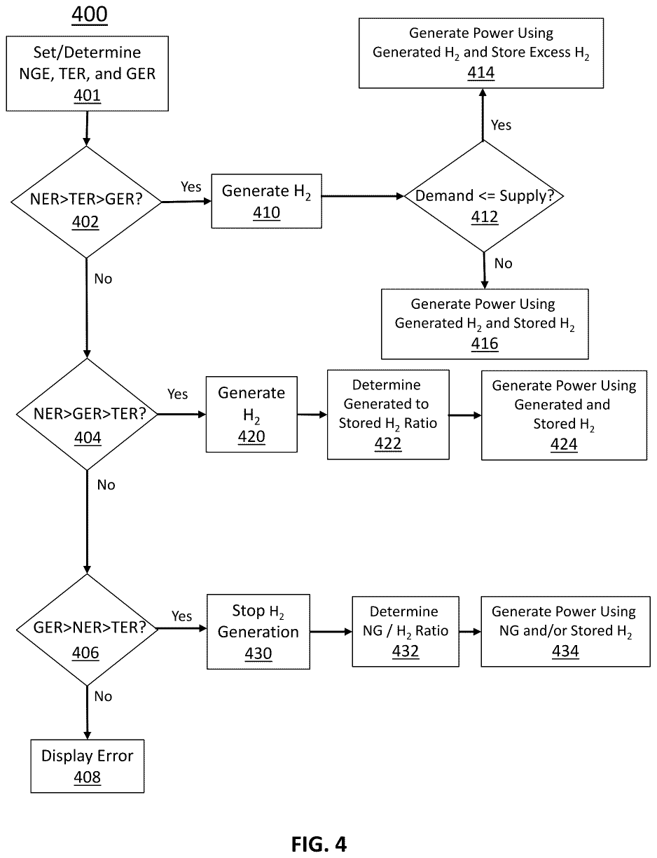

FIG. 4 is a flow chart depicting a method 400 of operating the system 200 of FIG. 2, according to the first embodiment of the present disclosure. Referring to FIGS. 2 and 4, in step 401, the method 400 may include setting and/or determining the NER, TER, and GER. For example, the emission rates may be set by the system operator or may be received from an external source, such as a grid utility, or may be estimated on various available data. The emission rates may be stored in a memory of the controller 210. Step 401 may occur continuously or periodically during operation of the system 200.

The method 400 then proceeds to decision blocks 402, 404 and 406. In the decision blocks 402, 404 and 406, the controller 210 may determine how to operate the system 200 based on a comparison of the magnitudes of the NER, TER, and GER, and thereby satisfy the TER. In particular, the method 400 proceeds from step 401 to decision block 402. In decision block 402, if the controller 210 determines that NER>TER>GER (i.e., that NER>TER>GER =YES), then the method 400 proceeds to step 410. If the determination in decision block 402 is that NER>TER>GER =NO, then method 400 proceeds to decision block 404. In decision block 404, if the controller 210 determines that NER>GER>TER (i.e., that NER>GER>TER=YES), then the method 400 proceeds to step 420. If the determination in decision block 404 is that NER>GER>TER=NO, then the method 400 proceeds to decision block 406. In decision block 406, if the controller 210 determines that GER>NER>TER (i.e., that GER>NER>TER=YES), then the method 400 proceeds to step 430. If the determination in decision block 406 is that GER>NER>TER=NO, then the controller 210 displays an error message to the system operator in step 408 because it is presumed that TER is always less than NER.

If a change in any of the GER, TER and/or NER values is detected in step 401, the method 400 may return to step 402. For example, if the TER is changed by the system operator, or if the GER changes due to a change in the ratio of renewable to fossil power provided to the power grid 50, step 402 may be repeated using the updated rate(s).

In step 410, the electrolyzer system 220 may be operated to generate hydrogen using electric power from the power grid 50. The controller 210 may open the steam valve 212 to provide steam from the steam supply 52 to the electrolyzer system 220 and switch on the electrolyzer system 220 power electronics to receive electric power from the power grid 50. For example, the power grid 50 may be provided with a significant amount of renewable electric power, such that the GER is less than both the NER and TER. As such, the power grid 50 may provide low-carbon electric power or carbon free electric power (if only renewable electric power is used by the power grid 50) to the electrolyzer system 220, in order to generate “green” hydrogen by electrolyzing steam provided by the steam supply 52. The hydrogen generated by the electrolyzer system 220 may be provided to the fuel cell system 230 to generate electric power.

The method 400 then proceeds from step 410 to decision block 412. In decision block 412, the controller 210 determines whether the amount of hydrogen supplied to the fuel cell system 430 by the electrolyzer system 420 is sufficient for the fuel cell system 430 to generate sufficient electric power from the supplied hydrogen to meet the power demand of the load 56. If the hydrogen supply is sufficient to meet the demand (i.e., the output of decision blow 412 is YES), then the method 400 proceeds to step 414. If the hydrogen supply is not sufficient to meet the demand (i.e., the output of decision blow 412 is NO), then the method 400 proceeds to step 416.

In step 414, the hydrogen production of the electrolyzer system 220 may exceed the hydrogen requirements of the fuel cell system 230 to power the load 56. In this case, excess hydrogen may be stored in the hydrogen storage device 240.

In step 416, the controller 210 may determine how much additional hydrogen fuel is required by the fuel cell system 230 to generate electric power to satisfy the electric power demand of the load 56. The controller 210 may provide a corresponding amount of hydrogen from the hydrogen storage device 240 to the fuel cell system 230 by opening the hydrogen valve 216 to make up for the deficit. In some embodiments, if the controller 210 determines that there is no hydrogen or insufficient hydrogen remaining in the hydrogen storage device 240 in order to power the fuel cell system 230 to meet the electric power demand of the load 56, then the controller 210 may open the fuel valve 214 to provide a hydrocarbon fuel (e.g., natural gas) from the fuel supply 54 to the fuel cell system 230 to make up for the deficit and/or return the method 400 to step 401.

In step 420, the electrolyzer system 220 may be operated to generate hydrogen using electric power from the power grid 50 as described above with respect to step 410. The method 400 then proceeds to step 422.

In step 422, the controller 210 calculates a ratio of generated hydrogen by the electrolyzer system 220 to stored hydrogen in the hydrogen storage device 240 that should be provided to the fuel cell system 230 to satisfy the TER. The controller 210 controls the steam valve 212 and the electrolyzer system 220 power electronics for the electrolyzer system 220 to receive the calculated amount of electric power from the power grid 50 and the calculated amount of steam from the steam supply 52 that would result in the amount of generated hydrogen that would satisfy the determined ratio of the generated hydrogen by the electrolyzer system 220 to the stored hydrogen in the hydrogen storage device 240. The controller 210 may also control the hydrogen valve 216 if it is a proportional valve to control an amount of the stored hydrogen provided from the hydrogen storage device 240 to the fuel cell system 230.

In step 424, the fuel cell system 430 is operated using both the generated hydrogen by the electrolyzer system 220 and the stored hydrogen in the hydrogen storage device 240 at the ratio calculated in step 422 to produce electric power for the load 56. Thus, the determined ratio of the generated hydrogen to the stored hydrogen is provided to the fuel cell system 230 to generate power for the load 56.

In step 430, the controller 210 stops the electrolyzer system 420 from producing hydrogen. The controller 210 closes the steam valve 212 (if it is open) to stop providing steam from the steam supply 52 to the electrolyzer system 220, and switches off the electrolyzer system 220 power electronics for the electrolyzer cell stack 100 to stop receiving electric power from the power grid 50. Some electric power from the power grid 50 may still be used by the electrolyzer system 220 to keep various heaters and other electrically powered components operating in a stand-by mode.

In step 432, the controller 210 determines a hydrocarbon fuel (e.g., natural gas) to stored hydrogen ratio that should be provided to the fuel cell system 230 from the fuel supply 54 and the hydrogen storage device 240, respectively, to satisfy the TER.

In step 434, the fuel cell system 430 is operated using both the hydrocarbon fuel from the fuel supply 54 and the stored hydrogen in the hydrogen storage device 240 at the ratio calculated in step 432 to produce electric power for the load 56. Thus, the determined ratio of the hydrocarbon fuel to the stored hydrogen is provided to the fuel cell system 230 to generate power for the load 56. In one embodiment, the controller 210 may alternate providing the hydrocarbon fuel and the hydrogen to the fuel cell system 230 by alternately opening and closing the fuel valve 214 and the hydrogen valve 216. In another embodiment, the controller 210 may provide a mixture of the hydrocarbon fuel and the hydrogen to the fuel cell system 230 by opening both the fuel valve 214 and the hydrogen valves 216 at the same time. In this embodiment, the valves 214, 216 may comprise proportional valves which are used to control the flow rate ratio of natural gas to hydrogen.

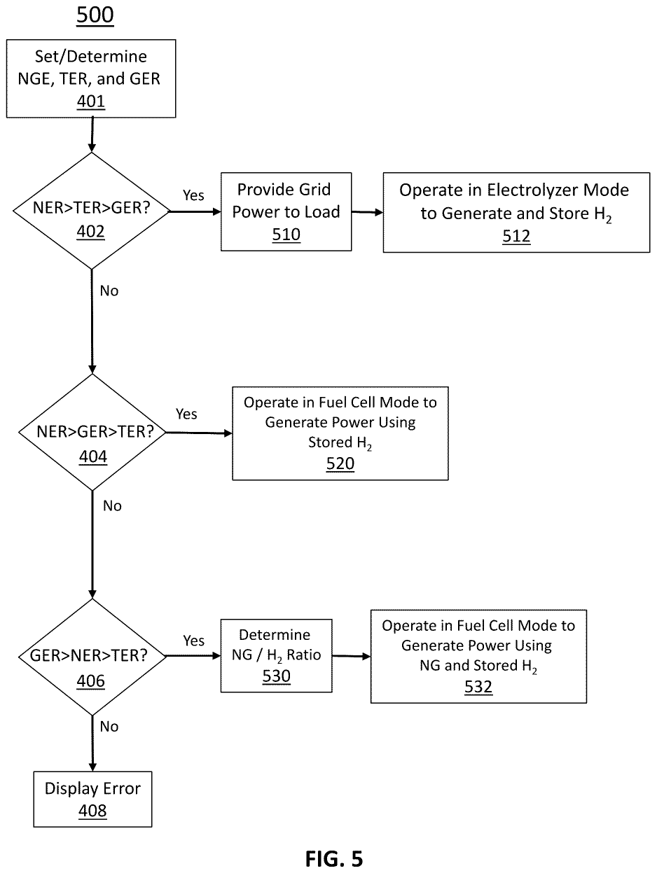

FIG. 5 is a flow chart depicting a method 500 of operating the system 202 of FIG. 3, according to the second embodiment of the present disclosure. Referring to FIGS. 3 and 5, the method 500 includes the same steps 401 and 408 and the same decision blocks 402, 404, 406 as the method 400.

In decision block 402, if the controller 210 determines that NER>TER>GER (i.e., that NER>TER>GER=YES), then the method 500 proceeds to step 510. If the determination in decision block 402 is that NER>TER>GER=NO, then method 500 proceeds to decision block 404. In decision block 404, if the controller 210 determines that NER>GER>TER (i.e., that NER>GER>TER=YES), then method 500 proceeds to step 520. If the determination in decision block 404 is that NER>GER>TER=NO, then the method 500 proceeds to decision block 406. In decision block 406, if the controller 210 determines that GER>NER>TER (i.e., that GER>NER>TER=YES), then the method 500 proceeds to step 530. If the determination in decision block 406 is that GER>NER>TER=NO, then the controller 210 displays an error message to the system operator in step 408 because it is presumed that TER is always less than NER.

In step 510, the load 56 may be powered using electric power provided from the power grid 50. For example, the power grid 50 may be a microgrid provided with DC power from a solar cell system or the like. In other embodiments, the power grid 50 may provide AC power and the load 56 may be an AC load or a DC load which includes a rectifier.

The method 500 then proceeds to step 512. In step 512, the reversible fuel cell system 250 may be operated in the electrolyzer mode to generate hydrogen using power supplied from the power grid 50 and steam supplied from the steam supply 52. For example, the power grid 50 may be provided with a significant amount of renewable power, such that the GER is less than both the NER and TER. As such, the power grid 50 may provide low-carbon or carbon free power to the system 250, in order to generate “green” hydrogen by electrolyzing steam provided by the steam supply 52. The generated hydrogen may be stored in the hydrogen storage device 240.

In step 520, the reversible fuel cell system 250 may be operated in the fuel cell mode using a hydrogen fuel to provide power to the load 56. In particular, the reversible fuel cell system 250 may be provided with hydrogen fuel from the hydrogen storage device 240 by opening the hydrogen valve 216.

In step 530, the controller 210 determines a hydrocarbon fuel (e.g., natural gas) to stored hydrogen ratio that should be provided to the reversible fuel cell system 250 from the fuel supply 54 and the hydrogen storage device 240, respectively, to satisfy the TER.

The method 500 then proceeds to step 532. In step 532, the reversible fuel cell system 250 is operated using both the hydrocarbon fuel from the fuel supply 54 and the stored hydrogen in the hydrogen storage device 240 at the ratio calculated in step 530 to produce electric power for the load 56. In one embodiment, the controller 210 may alternate providing the hydrocarbon fuel and the hydrogen to the reversible fuel cell system 250 by alternately opening and closing the fuel valve 214 and the hydrogen valve 216. In another embodiment, the controller 210 may provide a mixture of the hydrocarbon fuel and the hydrogen to the reversible fuel cell system 250 by opening both the fuel valve 214 and the hydrogen valves 216 at the same time. In this embodiment, the valves 214, 216 may comprise proportional valves which are used to control the flow rate ratio of natural gas to hydrogen.

According to various embodiments, electrochemical cell systems are provided that allow for a load to be continuously provided with power while generating limited or no carbon dioxide emissions. Various embodiments may generate hydrogen when sufficiently low carbon or carbon free electric power is available and utilizing the generated hydrogen when the sufficiently low carbon or carbon free electric power is not available, to reduce overall system carbon emissions.

The first embodiment of FIG. 2 includes a system 200 comprised of an electrolyzer system and a fuel cell system in tandem, which may continuously generate electricity and have the capability of storing the hydrogen when the hydrogen supply exceeds the demand. A zero carbon target emission rate (TER=0) or a TER value greater than zero can be provided to the system controller 210.

To make the entire methods 400 or 500 without any carbon (e.g., carbon dioxide) emissions, all of the electric power comes from at least one renewable power source, such as wind or solar. The methods 400 and 500 account for the source of the electric power, such that the electrolyzer system or the reversible fuel cell system is producing hydrogen whenever there sufficient renewable electric power available. The hydrogen is stored and then used as a fuel cell to generate power when the electric power from the power grid has a relatively high GER (e.g., when a larger part of electric power from the power grid is not from renewable power sources). The methods 400 and 500 include several operating modes depending on the TER being zero or a reduced level of carbon emission. The methods 400 and 500 can switch operating modes once the stored hydrogen falls below a certain point. Thus, the methods 400 and 500 can be utilized to generate electric power based on a target carbon emission number (which can also be zero carbon emission when only renewable power sources are used).

Fuel cell systems and electrolyzer systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention.

What is claimed is:

1. A method of operating a power system comprising a fuel cell system and an electrolyzer system, the method comprising:
(A) determining a CO₂ per kilowatt hour (kWh) power grid emission rate (GER) of a power grid electrically connected to the power system; and
(B) controlling operation of the power system based on a comparison between the GER, a CO₂ per kWh hydrocarbon fuel emission rate of the fuel cell system (NER), and a CO₂ per kWh target emission rate (TER) that is less than the NER, wherein:
if NER>TER>GER, controlling the power system to provide power from the power grid to the electrolyzer system to generate hydrogen, and provide the generated hydrogen to the fuel cell system to generate power for a load;
if NER>GER>TER, controlling the power system to provide power from the power grid to the electrolyzer system to generate hydrogen, and provide the generated hydrogen and stored hydrogen that was previously generated by the electrolyzer system to the fuel cell system to generate power for the load; and
if GER>NER>TER, then controlling the power system to provide the stored hydrogen and a hydrocarbon fuel to the fuel cell system to generate power for the load.

2. The method of claim 1, wherein if NER>TER>GER, controlling the power system:
to provide additional stored hydrogen to the fuel cell system if the generated hydrogen is less than an amount of hydrogen required for the fuel cell system to generate power which satisfies a power demand of the load; and
to store excess hydrogen if the generated hydrogen is greater than an amount of hydrogen required for the fuel cell system to generate the power which satisfies the power demand of the load.

3. The method of claim 1, wherein if NER>GER>TER, controlling the power system:
to determine a ratio of the generated hydrogen by the electrolyzer system to the stored hydrogen that should be provided to the fuel cell system to satisfy the TER; and
to provide the determined ratio of the generated hydrogen to the stored hydrogen to the fuel cell system to generate power for the load.

4. The method of claim 1, wherein the electrolyzer system does not generate hydrogen after determining that GER>NER>TER.

5. The method of claim 4, wherein the power system is further controlled to:
determine a ratio of a hydrocarbon fuel to the stored hydrogen that should be provided to the fuel cell system to satisfy the TER; and
provide the determined ratio of the hydrocarbon fuel to the stored hydrogen to the fuel cell system to generate power for the load.

6. The method of claim 5, wherein the hydrocarbon fuel comprises natural gas, and the hydrocarbon fuel emission rate (NER) of the fuel cell system comprises a natural gas emission rate of the fuel cell system.

7. The method of claim 5, wherein providing the determined ratio of the hydrocarbon fuel to the stored hydrogen to the fuel cell system comprises alternately providing the hydrocarbon fuel and the stored hydrogen to the fuel cell system.

8. The method of claim 5, wherein providing the determined ratio of the hydrocarbon fuel to the stored hydrogen to the fuel cell system comprises providing a mixture of the hydrocarbon fuel and the hydrogen to the fuel cell system.

9. The method of claim 1, wherein:
the method further comprises periodically or continuously repeating step (A) and step (B);
the power grid receives power from at least one intermittent renewable energy power source and from at least one fossil fuel power source, and the GER is a function of a ratio of power provided to the power grid from the at least one intermittent renewable energy power source to power provided to the power grid from the at least one fossil fuel power source;
the fuel cell system comprises at least one stack of solid oxide fuel cells; and
the electrolyzer system comprises at least one stack of solid oxide electrolyzer cells.

10. A method of operating a reversible fuel cell system, the method comprising:
(A) determining a CO₂ per kilowatt hour (kWh) power grid emission rate (GER) of a power grid electrically connected to the reversible fuel cell system; and
(B) controlling the reversible fuel cell system based on a comparison between the GER, a CO₂ per kWh hydrocarbon fuel emission rate of the reversible fuel cell system (NER), and a CO₂ per kWh target emission rate (TER) that is less than the NER, wherein:
if NER>TER>GER, operating the reversible fuel cell system in an electrolyzer mode using power received from the power grid to generate hydrogen, and storing the generated hydrogen;
if NER>GER>TER, operating the reversible fuel cell system in a fuel cell mode using stored hydrogen to generate power that is provided to a load; and
if GER>NER>TER, operating the reversible fuel cell system in the fuel cell mode using stored hydrogen and a hydrocarbon fuel to generate power that is provided to the load.

11. The method of claim 10, wherein if NER>TER>GER, providing power from the power grid to the load.

12. The method of claim 10, wherein if GER>NER>TER:
determining a ratio of a hydrocarbon fuel to stored hydrogen that should be provided to the reversible fuel cell system to satisfy the TER; and
providing the determined ratio of hydrocarbon fuel to stored hydrogen to the reversible fuel cell system to generate power for the load.

13. The method of claim 12, wherein the hydrocarbon fuel comprises natural gas, and the NER comprises a natural gas emission rate of the reversible fuel cell system when operating in the fuel cell mode.

14. The method of claim 12, wherein the step of providing the determined ratio of hydrocarbon fuel to stored hydrogen to the reversible fuel cell system comprises alternately providing hydrocarbon fuel and stored hydrogen to the reversible fuel cell system.

15. The method of claim 12, wherein the step of providing the determined ratio of hydrocarbon fuel to stored hydrogen to the reversible fuel cell system comprises providing a mixture of hydrocarbon fuel and hydrogen to the reversible fuel cell system.

16. The method of claim 10, wherein:
the method further comprises periodically or continuously repeating step (A) and step (B);
the power grid receives power from at least one intermittent renewable energy power source and from at least one fossil fuel power source, and the GER is a function of a ratio of power provided to the power grid from the at least one intermittent renewable energy power source to power provided to the power grid from the at least one fossil fuel power source; and
the reversible fuel cell system comprises at least one stack of solid oxide reversible fuel cells.

17. A power generation system that is configured to be electrically connected to a power grid and a load, the system comprising:
an electrolyzer system configured to generate hydrogen using power received from the power grid;
a hydrogen storage device configured to store the generated hydrogen;
a fuel cell system configured to generate power for the load using at least one of hydrogen received directly from the electrolyzer system, hydrogen received from the hydrogen storage device, or a hydrocarbon fuel received from a hydrocarbon fuel supply; and
a controller configured to:
(A) determine a CO₂ per kilowatt hour (kWh) power grid emission rate (GER) of a power grid electrically connected to the power system; and
(B) control operation of the power generation system based on a comparison between the GER, a CO₂ per kWh hydrocarbon fuel emission rate of the fuel cell system (NER), and a CO₂ per kWh target emission rate (TER) that is less than the NER, wherein:
if NER>TER>GER, control the power generation system to provide power from the power grid to the electrolyzer system to generate hydrogen, and provide the generated hydrogen to the fuel cell system to generate power for a load;
if NER>GER>TER, control the power generation system to provide power from the power grid to the electrolyzer system to generate hydrogen (H₂), and provide generated hydrogen and stored hydrogen that was previously generated by the electrolyzer system to the fuel cell system to generate power for the load; and
if GER>NER>TER, control the power generation system to provide the stored hydrogen and a hydrocarbon fuel to the fuel cell system to generate power for the load.

18. The system of claim 17, further comprising:
a steam valve configured to control steam flow from a steam supply to the electrolyzer system;
a fuel valve configured to control hydrocarbon fuel flow from the hydrocarbon fuel supply to the fuel cell system; and
a hydrogen valve configured to control hydrogen flow from the hydrogen storage device to the fuel cell system.

19. The system of claim 17, wherein:
the fuel cell system comprises at least one stack of solid oxide fuel cells; and
the electrolyzer system comprises at least one stack of solid oxide electrolyzer cells.

20. A power generation system that is configured to be electrically connected to a power grid and a load, the system comprising:
a hydrogen storage device configured to store generated hydrogen;
a reversible fuel cell system configured to generate hydrogen using power received from the power grid in an electrolysis mode, and to generate power for the load using at least one of hydrogen received from the hydrogen storage device or a hydrocarbon fuel received from a hydrocarbon fuel supply in a fuel cell mode; and
a controller configured to:
(A) determine a CO₂ per kilowatt hour (kWh) power grid emission rate (GER) of a power grid electrically connected to the reversible fuel cell system; and
(B) control the reversible fuel cell system based on a comparison between the GER, a CO₂ per kWh hydrocarbon fuel emission rate of the reversible fuel cell system (NER), and a CO₂ per kWh target emission rate (TER) that is less than the NER, wherein:
if NER>TER>GER, controlling the power generation system to operate the reversible fuel cell system in the electrolyzer mode using power received from the power grid to generate hydrogen, and storing the generated hydrogen;
if NER>GER>TER, controlling the power generation system to operate the reversible fuel cell system in the fuel cell mode using stored hydrogen to generate power that is provided to a load; and
if GER>NER>TER, controlling the power generation system to operate the reversible fuel cell system in the fuel cell mode using stored hydrogen and a hydrocarbon fuel to generate power that is provided to the load.
